(19) United States
(12) Patent Application Publication
(10) Pub. No.: US 2005/0095102 A1
(43) Pub. Date: May 5, 2005

(54) Cargo rack

(76) Inventor: Brad E. Watson, Sharin (CA)

Correspondence Address: Mr. Robin W. Asher;Clark Hill, P.L.C., Suite 3500, 500 Woodward Avenue, Detroit, MI, 48226-3435, US

(21) Appl. No.: 10/975,630

(22) Filed: Oct. 28, 2004

Related U.S. Application Data
(60) Provisional application No. 60/516,804, filed on Nov. 3, 2003.

(51) Int. Cl. B60P 9/00

(52) U.S. Cl. 414/462

(57) ABSTRACT

A cargo rack for mounting to the exterior surface of a vehicle includes a frame mounted to the vehicle and a cargo carriage to receive the cargo. The cargo carriage can be moved between a loaded position over the exterior surface of the vehicle and a loading/unloading position behind and below the exterior surface. The cargo carriage can include a variety of tie downs, for general cargo, or custom carriers for particular cargo, such as bicycles.

### FIELD OF THE INVENTION

The present invention relates to a cargo rack for motor vehicles. More specifically, the present invention relates to a cargo rack for a motor vehicle which cargo rack is movable between a loading/unloading position and a loaded position.

### BACKGROUND OF THE INVENTION

Cargo racks for motor vehicles are well known. Many motor vehicles have cargo racks comprising frames and/or rails on their exterior surfaces, such as their roof, on which luggage or other cargo can be placed for transport. Typically, such cargo racks include strips or rails on which the cargo is placed to prevent the cargo from directly contacting the vehicle surface to prevent damage thereto and/or to spread the load of the cargo over a larger area of the vehicle surface to prevent deformation of vehicle body panels. Further, cargo racks typically provide some mechanism, such as surrounding rails, tie downs and/or enclosures to prevent undesired movement of the cargo on the surface and to keep the cargo on the cargo rack while the vehicle moves.

However, problems exist with conventional cargo racks. For example, many cargo racks can be hard to load and unload. Specifically, as the cargo racks are typically located on surfaces on the motor vehicle which are significantly above the road surface, such as the vehicle roof, it can be difficult for most individuals to reach the vehicle roof to load and unload the cargo. This is especially problematic in tall vehicles such as Sport Utility Vehicles (SUVs) or mininvans where the roof can be a significant height above the road surface.

In many cases, an individual attempting to load or unload cargo from a roof cargo rack on such vehicles must use a step ladder, or other ladder, to gain access to the cargo rack. While this can work reasonably well, it requires the individual to have access to such a ladder when both loading and unloading cargo. Further, the individual must still move cargo, which can be heavy and/or awkwardly sized, between low and high locations which provides a significant opportunity for the individual to fall and/or for the cargo to be damaged. In other cases, the individual can open one of the vehicle doors and stand on the door threshold to access the cargo rack, but this is, at best, an awkward stance to maintain safely and, at worst, a dangerous stance when loading or unloading heavy cargo as the individual can easily loose their balance and fall, or injure their back, etc. due to the required twisting and lifting motion required.

It is desired to have a cargo rack which provides improved access for loading and/or unloading of cargo.

### SUMMARY OF THE INVENTION

It is an object of the present invention to provide a novel cargo rack for motor vehicles which obviates or mitigates at least one disadvantage of the prior art.

According to a first aspect of the present invention, there is provided a cargo rack for attachment to an external surface of a vehicle, the rack comprising: a frame attached to the vehicle, the frame including side rails extending longitudinally along the vehicle surface; an intermediate carriage having rollers at one end of each of a pair of sides, the rollers engaging a respective side rail of the frame; a pair of support arms having one end pivotally attached to the vehicle below the frame and the other end pivotally attached to the intermediate carriage adjacent the end opposite to the end with the rollers to allow the intermediate carriage to move longitudinally with respect to the frame; a cargo carriage having rollers on a pair of sides, the rollers engaging sides of the intermediate carriage to allow the cargo carriage to move longitudinally with respect to the intermediate carriage; and drive means to move the cargo carriage between a loaded position over the external surface of the vehicle and a loading/unloading position below and behind the external surface position.

Preferably, the cargo rack can receive a variety of carriers for holding particular types of cargo. Also preferably, the cargo rack has a plurality of tie downs to which a retaining device can be fastened to secure cargo.

### BRIEF DESCRIPTION OF THE DRAWINGS

Preferred embodiments of the present invention will now be described, by way of example only, with reference to the attached Figures, wherein:

FIG. 1 shows a top view of a cargo rack in accordance with the present invention;

FIG. 2 shows a perspective view of a the front portion of the cargo rack of FIG. 1;

FIG. 3 shows an exploded view of the interconnection, in turn, of a cargo carriage to an intermediate carriage and to a frame of the rack of FIG. 1;

FIG. 4a shows a side view of the cargo rack of FIG. 1 in a loading/unloading position;

FIG. 4b shows a side view of the cargo rack of FIG. 1 moving to a loaded position;

FIG. 5 shows a side view of the cargo rack of FIG. 1 in a loaded position;

FIG. 6 shows a side view of the cargo rack of FIG. 1 in a position intermediate loaded and loading/unloading positions;

FIG. 7 shows a side view of the cargo rack of FIG. 1 in a loading/unloading position;

FIG. 8a shows an exploded view of a tie down of the present invention;

FIG. 8b shows a side view of the tie down of FIG. 8a in a storage position and an in-use position; and

FIG. 9 shows a perspective view of a moveable tie down of the present invention.

### DETAILED DESCRIPTION OF THE INVENTION

As used herein, the term cargo rack is intended to encompass luggage racks, carrier racks and other devices for carrying luggage or cargo on an exterior surface of a motor vehicle. While the following discussion is limited, for clarity, to a cargo rack located on the roof of a vehicle, the present invention is not so limited and it is contemplated that the present invention can also be employed on top of engine compartment hoods, vehicle trunks and/or in the cargo box of pick up trucks and the like. In the later case, the present invention provides an improved mechanism for loading and unloading cargo into the cargo box of pick up trucks and the like and can provide enhanced tie down capabilities.

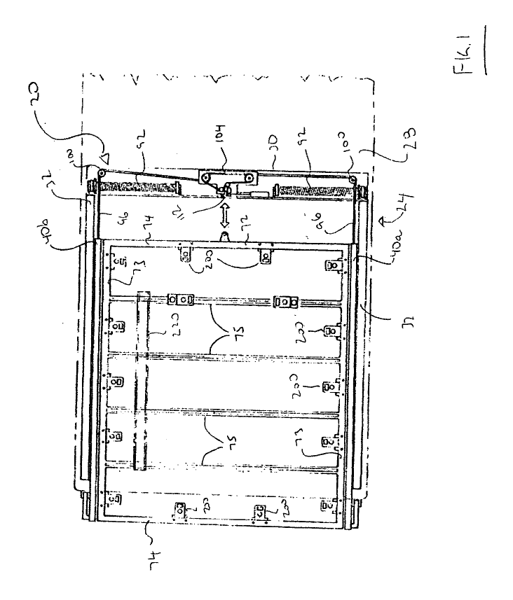

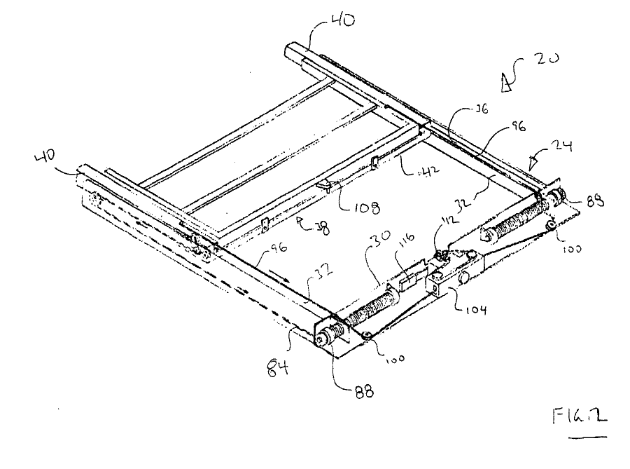

Referring to FIG. 1, a cargo rack in accordance with the present invention is indicated generally at 20. Rack 20 includes a frame 24 which is mounted to a motor vehicle 28 by any suitable means. Frame 24 includes a front rail 30 which extends across vehicle 28 (shown in ghosted line in FIG. 1) and a pair of parallel and spaced side rails 32 and 32, which extend longitudinally along vehicle 28, best seen in FIG. 2. Each side rail 32 including an inwardly facing channel 36 and each side rail 32 has end stops (not shown) closing each end of channels 36.

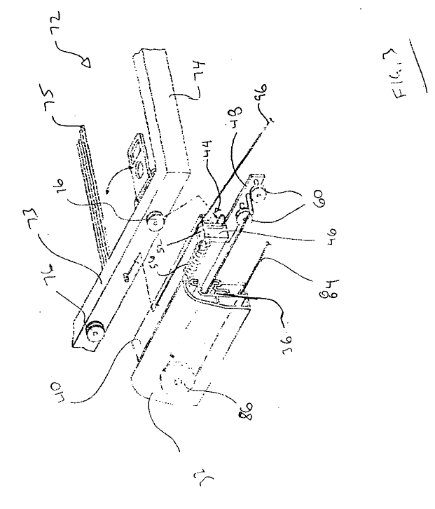

A rectangular intermediate carriage 38 comprising a pair of side rails 40, each extending parallel to a respective one of side rails 32 and front 42 and rear (not shown) cross pieces extending parallel to front rail 30, is located within frame 24. Each rail 40 includes an inwardly facing generally C-shaped channel 44 and a downwardly facing generally C-shaped channel 46 as shown in FIG. 3.

The end of rails 40 adjacent front rail 30, hereinafter the “front ends”, are interconnected to a respective side rail 32 by an L-shaped runner assembly 48, best seen in FIG. 3. Each runner assembly 48 includes a roller 52 which is received in channel 46 of a respective intermediate rail 40 and allows runner assembly 48 to move along channel 46 within a bounded range of movement. Specifically, an end plate across channel 46 prevents roller 52 from exiting the front end of channel 46 and a coil spring 56, one end of which is attached to rail 40 and the other end of which is attached to runner assembly 48, biases runner assembly 48 away from the front end and prevents roller 52 from moving past the attachment point of coil spring 56 to rail 40.

Each runner assembly 48 further includes a pair of rollers 60 which ride in a respective channel 36 of side rail 32 allowing intermediate carriage 38 to move longitudinally with respect to frame 24.

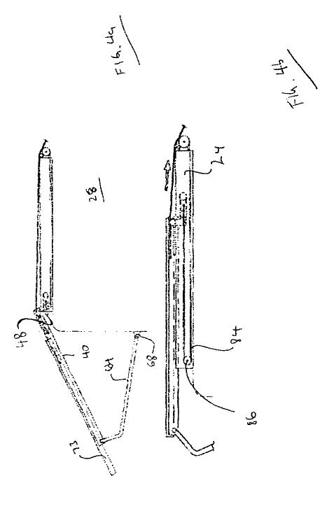

The ends of rails 40 distal front rail 30 and adjacent to the rear cross piece of intermediate carriage 38, hereinafter the “back ends”, are each pivotally connected to one end of a pair of support arms 64, best seen in FIG. 4a, and the other end of support arms 64 are pivotally connected to mount points 68 on vehicle 28.

Rack 20 further includes a cargo carriage 72 which comprises two longitudinal frame members 73 and a two lateral frame members 74 and, in the illustrated embodiment, four cross members 75 making a rectangular frame on which cargo can be loaded.

Each of frame members 73 includes a pair of rollers 76 which engage channel 44 of a respective rail 40 and allow cargo carriage 72 to move longitudinally with respect to intermediate carriage 38 which is, in turn, able to move longitudinally with respect to frame 24.

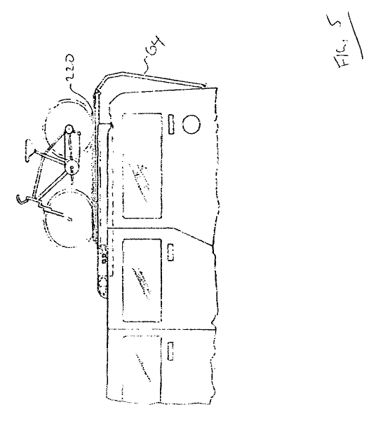

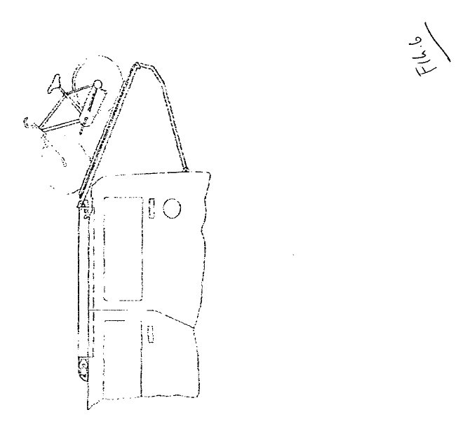

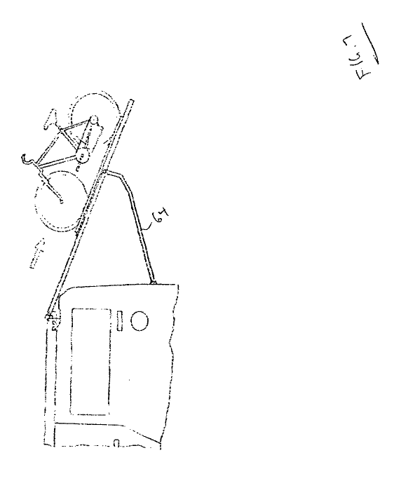

As should now be apparent, cargo carriage 72 is within frame 24 and on top of intermediate carriage 38 and cargo carriage 72 can be moved between a loaded position, illustrated in FIG. 5 through the intermediate position shown in FIG. 6 to the loading/unloading position shown in FIG. 7, each of which is described in more detail below.

Movement of cargo carriage 72 is accomplished by two opposed sets of cables. A deployment set of cables 84 each have one end anchored to a respective one of runner assemblies 48 and pass over a pulley 86 mounted within the back end of side rails 32. The other end of cables 84 are anchored to a drive pulley 88, each of which is connected to a respective torsion spring 92 which operates to tension cables 84 such that intermediate carriage 38 is biased to the position shown in FIG. 6 by torsion springs 92 as cables 84 pull runner assemblies 48 to the back of rails 32.

A pair of retraction cables 96 are also employed, one end of each cable 96 being anchored to cargo carriage 72. The cables 96 pass over a pulley 100 mounted to front rail 30 with the other end being anchored to an electrically driven windlass 104.

When rack 20 is in the loaded position, illustrated in FIG. 5, windlass 104 has been driven to retract cables 96, drawing cargo carriage 72 and the intermediate carriage forward to the position shown in the Figure. With the intermediate carriage and cargo carriage 72 are in this position, deployment cables 84 are fully extended and torsion springs 92 are wound up. To maintain cargo carriage 72 in the illustrated loaded position, a latch pin 108 mounted on the front of cargo carriage 72 engages a solenoid operated latch 112 on front rail 30.

A microcontroller, not shown, is employed with rack 20 to operate windlass 104 and latch 112 as described herein. To move cargo carriage 72 to the loading/unloading position illustrated in FIG. 7, from the loaded position illustrated in FIG. 5, the microcontroller is activated and opens latch 112, releasing latch pin 108. The microcontroller then commences unwinding windlass 104, paying out retraction cables 96. Torsion springs 92 apply tension to deployment cables 84 which draw intermediate carriage 38 back, away from front rail 30, until intermediate carriage 38 and cargo carriage 72 are in the position illustrated in FIG. 6.

At this point, rollers 60 of runner assemblies 48 are abutting end stops in channels 36 of side rails 32 and further backward movement of intermediate carriage 38 is prevented. As will be apparent to those of skill in the art, the L-shape of runner assemblies 48 means that roller 52 abuts the end stop of channel 46 at a point above and behind the back end of side rails 32, allowing intermediate carriage 38 to clear the edge of the vehicle roof, as best seen in FIG. 4a.

The L-shaped runner assemblies 48 provide a “lost motion” connection between the cargo carriage 72 and the rails 40. Once the runner assemblies 48 encounter the end of travel, the carriage 72 continues to travel relative to the rails 40. The “lost motion” connection enables the pivot point of the carriage 72 to move rearwardly so that the pivoting movement of the carriage 72 does not contact the body of the vehicle 28.

Windlass 104 continues to pay out retraction cables 96 which allow rollers 76 to move along channels 44 in rails 40 as gravity draws cargo carriage 72 to the loading/unloading position illustrated in FIG. 7. The microcontroller monitors the length of retraction cables 96 deployed, by counting revolutions of the cable drum of windlass 104, or by any other suitable means, and stops paying out cables 96 when it has determined that cargo carriage 72 is in the loading/unloading position. The microcontroller can also be responsive to pressure and/or non-contact sensors to ensure that movement of cargo rack 72 immediately ceases if an unsafe operating condition is encountered, such as the presence of a foreign body preventing deployment or retraction of cargo carriage 72, etc.

When cargo carriage 72 is in the loading/unloading position illustrated in FIG. 7, cargo can easily be loaded onto carriage 72 or unloaded therefrom.

Once loading and/or unloading has been completed, the microcontroller is activated and windlass 104 pulls in retraction cables 96, and again can monitor tension and/or pressure sensors to ensure safe operation. As retraction cables 96 are wound onto windlass 104, cargo carriage 72 is drawn onto intermediate carriage 38 until rollers 76 abut end stops in channels 44. Then, as cables 96 continue to be wound onto windlass 104, cargo carriage 72 draws intermediate carriage 38 forward, as shown in FIG. 4b, tensioning deployment cables 84 and torsion springs 92. Coil springs 56 move rollers 52 back away from the end stops of channels 46 as intermediate carriage 38 and cargo carriage 72 move forward along vehicle 28 to bring the front edge of cargo carriage 72 approximately even with the front edge of intermediate carriage 36.

A microswitch 116 on front rail 30 detects when cargo carriage 72 is in the loaded position and the microcontroller shuts latch 112 onto latch pin 108 and shuts down windlass 104. Cargo carriage 72 is now in the position shown in FIG. 7.

The configuration described above, with deployment cables 84 and retraction cables 96, is presently preferred as it provides a degree of positive deployment capability. Specifically, in this configuration, movement of cargo carriage 72 to the loading/unloading position is not dependent upon gravity and can be achieved even if vehicle 28 is in a somewhat front-down inclined position as deployment cables and torsion springs 92 operate to “pull” intermediate carriage 38 to the position shown in FIG. 6. However, it is contemplated that the present invention can also be successfully deployed in some circumstances with only retraction cables 96 and relying upon gravity to deploy intermediate carriage 38. In such a case, frame 24 may be inclined rearwardly a few degrees on vehicle 28 to facilitate gravity driven deployment of intermediate carriage 38.

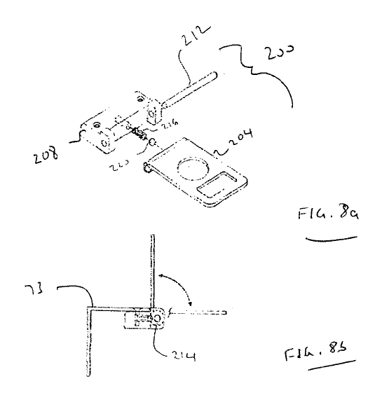

Another advantage of rack 20 is that cargo carriage 72 includes a variety of retractable tie downs 200, best seen in FIGS. 8a and 8b. Tie downs 200 include a plate 204, with one or more apertures to receive a rope or other retaining device, and a base 208 which can be fastened to the rails of cargo carriage 72. Plate 204 is pivotally attached to base 208 via a pin 212, allowing plate 204 to be rotated between a storage position, shown in FIG. 8a and an in-use position, shown in FIG. 8b. A detent 214 on plate 204 cooperates with a spring 216 and ball bearing 220 in base 208 to maintain plate 204 in the storage position when tie down 200 is not being used.

In addition to the tie downs 200 attached to the rails of cargo carriage 72, it is contemplated that a variety of carriers and/or utility hardware can be mounted to cross members 75 of cargo carriage 72. For example, a bicycle carrier 220 can be mounted to cross members 75 as illustrated in FIGS. 1, 5, 6 and 7. It is contemplated that ski racks, cargo boxes and other carriers can all be employed with the present invention.

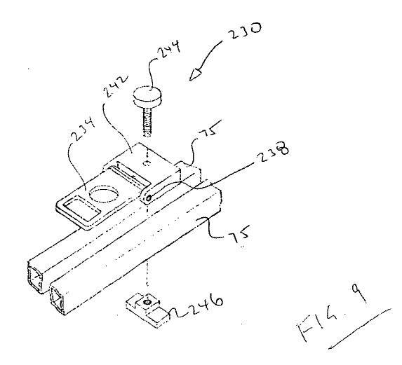

Also, as shown in FIG. 9 a moveable tie down 230, similar to tie downs 200, can be provided for attachment to cross members 75. Moveable tie down 230 includes a plate 234 which is pivotally attached by a pin 238 to a base 242 in a manner similar to that shown for tie downs 200, including a spring, ball bearing and detent mechanism to maintain plate 234 in a storage position. Base 242 differs from base 208 in that it is mounted to the upper side of cross members 75 and attaches, via screw 244 to a runner 246 which engages the underside of cross members 75. Screw 244 has a knurled head can be loosened by a user and moved along cross members 75 to a desired position and then retightened as needed.

The embodiment of the present invention discussed above is suitable for use as either OEM or after market installations. However, it is further contemplated that in OEM circumstances, support arms 64 can be designed into the body of vehicle 28 to provide a different appearance. For example, support arms can be countersunk and/or flush mounted in the rear corner pillars of the body of vehicle 28.

The above-described embodiments of the invention are intended to be examples of the present invention and alterations and modifications may be effected thereto, by those of skill in the art, without departing from the scope of the invention which is defined solely by the claims appended hereto.

1. A cargo rack for attachment to an external surface of a vehicle, the rack comprising:
a frame attached to the vehicle, the frame including side rails extending longitudinally along the vehicle surface;
an intermediate carriage having rollers at one end of each of a pair of sides, the rollers engaging a respective side rail of the frame;
a pair of support arms having one end pivotally attachable to the vehicle below the frame and the other end pivotally attached to the intermediate carriage adjacent the end opposite to the end with the rollers to allow the intermediate carriage to move longitudinally with respect to the frame;
a cargo carriage having rollers on a pair of sides, the rollers engaging sides of the intermediate carriage to allow the cargo carriage to move longitudinally with respect to the intermediate carriage; and
drive means to move the cargo carriage between a loaded position over the external surface of the vehicle and a loading/unloading position below and behind the external surface position.

2. The cargo rack of claim 1 wherein the drive means comprises a first set of cables biased by springs to move the intermediate carriage backward with respect to the frame and a second set of cables connected to a motor driven windlass, the windlass operable to wind in the second set of cables to move the cargo carriage and the intermediate carriage to the loaded position and to unwind the second set of cables to allow the intermediate carriage to move backward and the cargo carriage to be moved to the loading/unloading position by the first set of cables.

3. The cargo rack of claim 1 wherein the cargo carriage includes a set of tie downs, each of the tie downs including a plate with at least one aperture to receive a retaining device and the plate being pivotable between a vertical in-use position and a horizontal storage position.

4. The cargo rack of claim 3 wherein at least one of the tie downs is moveable about the cargo carriage.

5. The cargo rack of claim 2 further including a microcontroller operable to control the windlass to move the cargo carriage between the loaded position and the loading/unloading position.

6. The cargo rack of claim 1 wherein the cargo carriage further includes a latch pin and the frame further includes a latch, the latch pin engaging the latch to maintain the cargo carriage in the loaded position.

7. The cargo rack of claim 2 wherein the cargo carriage further includes a latch pin and the frame further includes a latch, the latch pin engaging the latch to maintain the cargo carriage in the loaded position and further including a microcontroller operable to control the windlass to move the cargo carriage between the loaded position and the loading/unloading position and to open and close the latch.
